(19) United States
(12) Patent Application Publication
(10) Pub. No.: US 2026/0259807 A1
(43) Pub. Date: Sep. 3, 2026

(54) TEST SYSTEM AND TESTING METHOD

(71) Applicant: ZF AIRBAG GERMANY GMBH, Aschau a. Inn (DE)

(72) Inventors: Frank GIESCHE, Waldstetten (DE); Andreas SCHACHTNER, Wurmannsquick (DE); Stefan WINKLER, Aalen (DE)

(21) Appl. No.: 19/164,642

(22) PCT Filed: Sep. 14, 2023
(86) PCT No.: PCT/EP2023/056408

§ 371 Date: Sep. 12, 2025

(51) Int. Cl. G06F 11/273

(52) U.S. Cl. CPC G06F 11/2733

(57) ABSTRACT

A test system (10) for performing tests on at least one device under test is described. The test system (10) comprises a resource module (20), a test module (22), and a user interface module (18). The resource module (20) comprises a resource database, wherein the resource database comprises resource data associated with a plurality of different test appliances for performing tests on a plurality of different devices under test. The test module (22) comprises a test database, wherein the test database comprises test data associated with a plurality of different tests for a plurality of different devices under test. The user interface module (18) is configured to receive a test request from a user, wherein the test request is associated with the at least one device under test. The test module (22) is configured to selectively transmit at least a subset of the test data, the subset of the test data corresponding to at least one test matching the test request to the user interface module (18). The resource module (20) is configured to selectively transmit at least a subset of the resource data, the subset of the resource data corresponding to at least one test appliance matching the test request to the user interface module (18). The user interface module (18) comprises a data interface, wherein the data interface is configured to couple the at least one subset of the test data with the at least one subset of the resource data, thereby obtaining combined test and resource data. Further, a testing method for performing tests on at least one device under test by means of a test system (10) is described.

### TECHNICAL FIELD

The invention generally relates to a test system for performing tests on at least one device under test. The invention further relates to a testing method for performing tests on at least one device under test by means of a test system.

### BACKGROUND

In a plurality of different technical fields, devices to be manufactured need to be tested at different stages of the lifecycle of the device.

For example, prototypes of the device may be tested with respect to desired and undesired properties in order to assess necessary changes to the prototype. As another example, individual components of the device may be tested with respect to their functionality before the device is assembled. In a further example, the device may be subjected to an end-of-line test in order to guarantee the errorless functionality of the device.

Many devices to be manufactured require different inter-regional, international or even global production stages, wherein different production stages may require different tests to be performed on the device to be manufactured, which leads to complex processes and thus complex data structures for coordinating the tests.

These complex processes require large amounts of data to be transferred between different production and/or testing sites. Moreover, adding new tests and/or procedures requires rather high effort and bears the risk of losing backward compatibility of the newly added data.

### SUMMARY

The object of the present invention is to provide a test system and a testing method for performing tests on a device under test that allow for performing tests in a more efficient manner.

According to the present invention, the problem is solved by a test system for performing tests on at least one device under test. The test system comprises a resource module, a test module, and a user interface module. The resource module comprises a resource database, wherein the resource database comprises resource data associated with a plurality of different test appliances for performing tests on a plurality of different devices under test. The test module comprises a test database, wherein the test database comprises test data associated with a plurality of different tests for a plurality of different devices under test. The user interface module is configured to receive a test request from a user, wherein the test request is associated with the at least one device under test. The user interface module is configured to forward the test request to the test module and to the resource module. The test module is configured to selectively transmit at least a subset of the test data, the subset of the test data corresponding to at least one test, particularly several different tests, matching the test request to the user interface module. The resource module is configured to selectively transmit at least a subset of the resource data, the subset of the resource data corresponding to at least one test appliance, particularly several different test appliances, matching the test request to the user interface module. The user interface module comprises a data interface, wherein the data interface is configured to couple the at least one subset of the test data with the at least one subset of the resource data, thereby obtaining combined test and resource data.

Therein and in the following, the term “module” is understood to describe suitable hardware, suitable software, or a combination of hardware and software that is configured to have a certain functionality.

The hardware may, inter alia, comprise a CPU, a GPU, an FPGA, an ASIC, a digital signal processor (DSP), or other types of electronic circuitry.

Further, the term “test data” is generally understood to denote data comprising information on tests that can be performed. For example, the test data may comprise a test library, a test case library, a test catalog, test reports, test documentation, test instructions, design verification plan(s) (DVP), product verification plan(s) (PVP), etc.

Moreover, the term “resource data” is understood to denote data comprising information on test appliances that can be used in order to perform tests-For example, the resource data may comprise a catalog of test appliances, an availability of the test appliances, a time of previous use of the test appliances, a remaining lifetime of the test appliances, a maintenance schedule of the test appliances, instructions for using the test appliances, a geographic location of the test appliances, a list of device under test being compatible with the test appliances, etc.

The term “test request” is understood to denote a request entered by a user to perform a certain test or several certain tests, and/or to perform test(s) on certain device(s) under test, which is collectively referred to as “the requested test(s)” hereinafter.

According to the present invention, the resource module and the test module operate on different sets of data, namely the resource data and the test data. Only the respective data that is associated with a requested test(s) is transferred to the user interface module, such that the amount of data that needs to be transferred is reduced significantly. Accordingly, the test system can be operated with a significantly enhanced data efficiency and thus with a significantly enhanced energy efficiency.

In other words, instead of transferring data that comprises all information associated with all different test appliances and all different tests associated with the at least one device under test, only the information that is actually relevant for the requested test(s) is transferred.

The at least one subset of the test data and the at least one subset of the resource data are coupled by means of the data interface. In the combined test and resource data, the information comprised in the subset of the test data and in the subset of the resource data is linked such that the combined test and resource data comprises information on viable combinations of tests and test appliances for the requested test(s).

In fact, the combined test and resource data allows the user to configure the test(s) to be performed based on the information on viable combinations of tests and test appliances for the requested test(s), such that the combined test and resource data allows the user to schedule and perform the requested test(s) in an efficient manner.

In other words, the test system according to the present disclosure is based on modular data, wherein the different modules, namely the test data and the resource data, are coupled by means of the user interface module, more precisely by means of the data interface.

This modular data approach allows for adapting the resource data and/or the test data without losing backward compatibility of the data, as will be described in more detail below.

According to an aspect of the present invention, the data interface is configured to couple the subset of the test data with the subset of the resource data by means of an asynchronous data coupling. In other words, the subset of the test data and the subset of the resource data may be transmitted to the user interface module in an asynchronous manner, i.e. the transfers of the subset of the test data and the subset of the resource data do not have to be synchronized with each other. Instead, the subset of the test data and the subset of the resource data can be transmitted to the user interface module independent of each other, e.g. by means of a message queuing protocol. This allows for a more efficient data transfer between the individual modules.

In an embodiment of the present invention, the resource data comprises a fixed attribute data portion associated with the plurality of different test appliances, and/or wherein the test data comprises a fixed attribute data portion associated with the plurality of different tests. The fixed attribute data portion corresponds to a predefined data portion that comprises necessary information for performing the tests on the at least one device under test.

Therein, a data structure of the fixed attribute data portion may be unalterable. In other words, while information comprised in the fixed attribute data portion may be configurable, the general structure of the fixed attribute data portion cannot be configured by a user. Due to the unalterable data structure, compatibility of the test data and/or the resource data, particularly backward compatibility of the test data and/or the resource data, is ensured.

Particularly, the fixed attribute data portion of the test data and the fixed attribute data portion of the resource data have the same data structure. This way, compatibility of the test data with the resource data is ensured.

According to another aspect of the present invention, the resource data comprises a configurable attribute data portion associated with the plurality of different test appliances, and/or wherein the test data comprises a configurable attribute data portion associated with the plurality of different tests. In general, the configurable attribute data portion corresponds to a data portion that comprises additional information for performing the tests on the at least one device under test.

Therein, the configurable attribute data portion may be freely configurable, such that arbitrary additional information can be provided. For example, the configurable attribute data portion may comprise additional definitions, comments, instructions for performing tests, additional test routines, test documentation, test reports, etc.

In a further embodiment of the present invention, the user interface module is configured to receive a test adaptation request, wherein the configurable attribute data portion of the test data is configurable by means of the test adaptation request. Accordingly, a user may adapt the configurable attribute data portion of the test data by means of the user interface module, thereby obtaining an adapted subset of the test data.

For example, the user may add new test routines, new test documentation, new test reports, or any other arbitrary information to the configurable attribute data portion of the test data.

The adapted subset of the test data may be transmitted to the test module. For example, the test database may be updated based on the adapted subset of the test data.

A further aspect of the present invention provides that the user interface module is configured to receive a resource adaptation request, wherein the configurable attribute data portion of the resource data is configurable by means of the resource adaption request. Accordingly, a user may adapt the configurable attribute data portion of the resource data by means of the user interface module, thereby obtaining an adapted subset of the test data.

For example, the user may add new test appliances, new test documentation, new test reports, or any other arbitrary information to the configurable attribute data portion of the resource data.

The adapted subset of the resource data may be transmitted to the resource module. For example, the resource database may be updated based on the adapted subset of the resource data.

The user interface module may be configured to receive user identification data from a user.

For example, the user identification data may comprise a user name, a user password, a department of the user, a job position of the user, or other suitable information on the user.

The user interface module may be configured to restrict read access and/or write access to the test data and/or the resource data based on the received user identification data.

For example, only certain employees, such as project leads, may be granted write access to modify the configurable attribute data portion of the test data and/or the configurable attribute data portion of the resource data described above.

Particularly, the data interface is configured to couple the subset of the test data with the subset of the resource data based on the user identification data. This way, customized combined test and resource data may be obtained that comprises only information that is actually relevant to the particular user.

In an embodiment of the present invention, the user interface module is configured to forward the user identification data to the resource module, and wherein the resource module is configured to selectively transmit the subset of the resource data based on the user identification data. In other words, only resource data that is actually relevant for the user and/or only resource data that the user is granted access to is transmitted to the user interface module, such that the amount of data to be transmitted is further reduced.

According to an aspect of the present invention, the user interface module is configured to forward the user identification data to the test module, and wherein the test module is configured to selectively transmit the subset of the test data based on the user identification data. In other words, only test data that is actually relevant for the user and/or only test data that the user is granted access to is transmitted to the user interface module, such that the amount of data to be transmitted is further reduced.

The user interface module may be configured to generate visualization data associated with the combined test and resource data. The generated visualization data may be displayed on a display, such that the combined test and resource data is presented to the user in an illustrative way.

The generated visualization data may, for example, comprise tables, diagrams, calendars, text fields, warning signs, and/or color-coded information.

Particularly, the user interface module may comprise a graphical user interface that allows the user to interact with the generated visualization data. For example, a user may schedule tests by means of the graphical user interface.

In a further embodiment of the present invention, the test system comprises at least one server, wherein the resource module and/or the test module is implemented on the at least one server, particularly on different servers. For example, the test database and/or the resource database may be established as a distributed database that is implemented on a plurality of servers, respectively.

According to the invention, the problem further is solved by a testing method for performing tests on at least one device under test by means of a test system, particularly by means of a test system described above. The testing method comprises the steps of:

receiving, by means of a user interface module, a test request from a user, wherein the test request is associated with at least one device under test;

forwarding, by means of the user interface module, the test request to a test module comprising a test database and to a resource module comprising a resource database, wherein the test database comprises test data associated with a plurality of different tests for a plurality of different devices under test, and wherein the resource database comprises resource data associated with a plurality of different test appliances for performing tests on a plurality of different devices under test;

selectively transmitting, by means of the resource module, a subset of the resource data corresponding to at least one test appliance, particularly several different test appliances, matching the test request to the user interface module;

selectively transmitting, by means of the test module, a subset of the test data corresponding to at least one test, particularly several different tests, matching the test request to the user interface module; and

coupling, by means of a data interface of the user interface module, the subset of the test data with the subset of the resource data, thereby obtaining combined test and resource data.

Particularly, the test system described above is configured to perform the testing method.

Regarding the further advantages and properties of the testing method, reference is made to the explanations given above with respect to the test system, which also hold for the test method and vice versa.

In an embodiment of the present invention, the subset of the test data is coupled with the subset of the resource data by means of an asynchronous data coupling. In other words, the subset of the test data and the subset of the resource data may be transmitted to the user interface module in an asynchronous manner, i.e. the transfers of the subset of the test data and the subset of the resource data do not have to be synchronized with each other. Instead, the subset of the test data and the subset of the resource data can be transmitted to the user interface module independent of each other, e.g. by means of a message queuing protocol. This allows for a more efficient data transfer within the test system.

According to an aspect of the present invention, the subset of the test data is synchronized with the subset of the resource data by means of a message queuing protocol. For example, the message queuing protocol may be an Advanced Message Queuing Protocol (AMQP).

### BRIEF DESCRIPTION OF THE DRAWINGS

The foregoing aspects and many of the attendant advantages of the claimed subject matter will become more readily appreciated as the same become better understood by reference to the following detailed description, when taken in conjunction with the accompanying drawings, wherein:

FIG. 1 schematically shows a test system according to the present invention;

FIG. 2 shows a diagram illustrating a data structure employed by the test system of FIG. 1; and

FIG. 3 shows a flow chart of a testing method according to the present invention.

### DESCRIPTION

The detailed description set forth below in connection with the appended drawings, where like numerals reference like elements, is intended as a description of various embodiments of the disclosed subject matter and is not intended to represent the only embodiments. Each embodiment described in this disclosure is provided merely as an example or illustration and should not be construed as preferred or advantageous over other embodiments. The illustrative examples provided herein are not intended to be exhaustive or to limit the claimed subject matter to the precise forms disclosed.

For the purposes of the present disclosure, the phrase “at least one of A, B, and C”, for example, means (A), (B), (C), (A and B), (A and C), (B and C), or (A, B, and C), including all further possible permutations when more than three elements are listed. In other words, the term “at least one of A and B” generally means “A and/or B”, namely “A” alone, “B” alone or “A and B”.

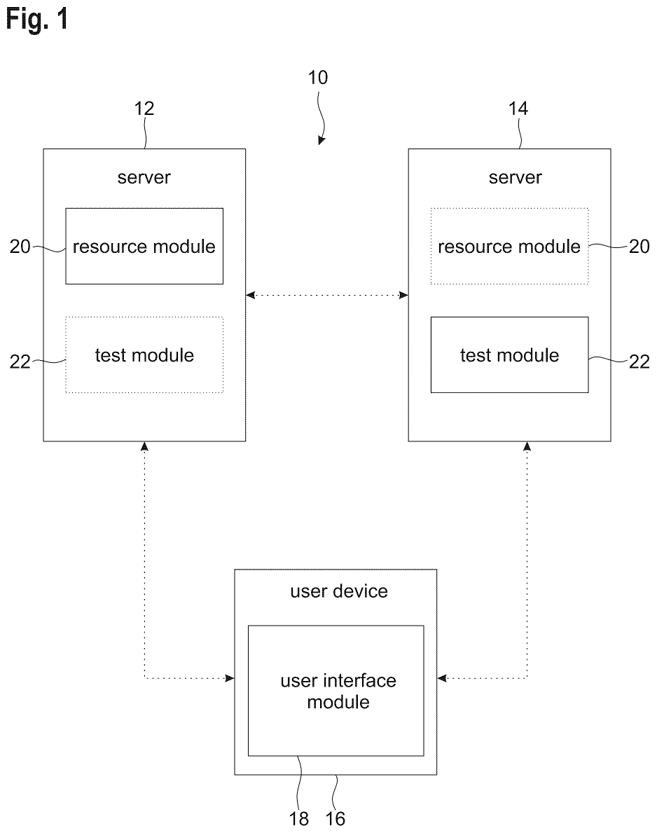

FIG. 1 schematically shows a test system 10 for performing tests on at least one device under test.

For example the device under test may be a vehicle or a component of a vehicle, such as an airbag, an engine, a drive train, a steering system, an electronic control module, etc.

However, it is to be understood that the test system 10 can be used for testing arbitrary devices under test, particularly arbitrary devices to be manufactured.

In the exemplary embodiment shown in FIG. 1, the test system 10 comprises a first server 12, a second server 14, and a user device 16.

It is noted that the test system 10 may comprise an arbitrary amount of servers other than two, for example a single server or at least three servers.

The user device 16 is connected with each of the servers 12, 14 in a signal-transmitting manner.

Moreover, the first server 12 and the second server 14 are connected with each other in a signal-transmitting manner.

Therein and in the following, the term “connected in a signal transmitting manner” is understood to denote a cable-based or wireless connection that is configured to transmit signals between the respective devices or components.

For example, the servers 12, 14 and the user device 16 may be connected with each other via a local area network (LAN), a wide area network (WAN), via the Internet, via a wireless network, particularly via a 5G network, etc.

In general, the user device 16 allows a user of the test system 10 to interact with the test system 10.

In fact, the user device 16 comprises a user interface module 18 that allows the user to interact with the test system 10, as will be described in more detail below.

For example, the user device 16 may be established as a personal computer, as a MAC, as a laptop, as a notebook, as a tablet, as a smart phone, or as another suitable type of smart device.

In the exemplary embodiment shown in FIG. 1, the test system 10 comprises a resource module 20 that is integrated into the first server 12, as well as a test module 22 that is integrated into the second server 14.

However, it is to be understood that the resource module 20 may be integrated into the first server 12 and/or the second server 14, as is indicated by the dotted lines in FIG. 1.

Likewise, the test module 22 may be integrated into the first server 12 and/or the second server 14, as is indicated by the dotted lines in FIG. 1.

Particularly, the servers 12, 14 may form a cloud, wherein the resource module 20 and/or the test module 22 may be integrated into the cloud.

The resource module 20 comprises a resource database, wherein the resource database comprises resource data associated with a plurality of different test appliances for performing tests on a plurality of different devices under test.

The test module 22 comprises a test database, wherein the test database comprises test data associated with a plurality of different tests for a plurality of different devices under test.

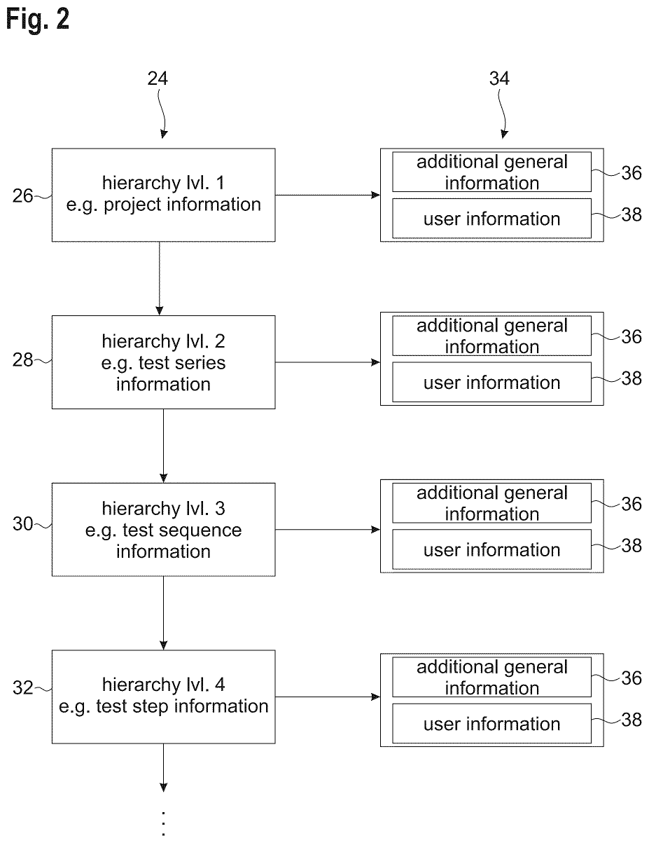

A data structure of the resource data and of the test data is illustrated in FIG. 2, respectively.

In the following, the data structure of the test data is described. However, it is to be understood that the explanations given hereinafter likewise apply to the resource data.

The test data comprises a fixed attribute data portion 24 being associated with the plurality of different tests.

In general, the fixed attribute data portion 24 corresponds to a predefined data portion of the test data that comprises necessary information for performing the tests on the at least one device under test.

As is illustrated on the left hand side of FIG. 2, the fixed attribute data portion may comprise hierarchy levels, i.e. the information comprised in the test data may be arranged according to hierarchy levels.

For example, a first hierarchy level 26 may comprise information on a respective project, such as deadlines, requirement specifications, variants of a device, team definitions, timelines, etc.

A second hierarchy level 28 may comprise information on a test series within the respective project, such as already reached milestones, milestones to be reached, a Global Development and Product Evolution Process (GDPEP), etc.

A third hierarchy level 30 may comprise information on a test sequence within the respective project, particularly within the respective test series, such as prototype samples, an order of tests to be performed, a bill of materials (BOM), etc.

A fourth hierarchy level 32 may comprise information on test steps within the respective project, particularly within the respective test series, for example within the respective test sequence. Particularly, the fourth hierarchy level 32 comprises information on test types, an order of test steps, instructions for performing test steps, etc.

As is indicated by the dots on the lower right hand side of FIG. 2, further and/or other hierarchy levels may be provided.

It is emphasized that the particular hierarchy described above is understood to be purely exemplary. In fact, the fixed attribute data portion 24 may have an arbitrary suitable data structure.

A data structure of the fixed attribute data portion 24 is unalterable. In other words, while information comprised in the fixed attribute data portion 24, e.g. the particular information comprised in the hierarchy levels 26, 28, 30, 32, may be configurable, the general structure of the fixed attribute data portion 24 cannot be configured by a user.

The test data further comprises a configurable attribute data portion 34 associated with the plurality of different tests.

In general, the configurable attribute data portion 34 corresponds to a data portion that comprises additional information for performing the tests on the at least one device under test.

As is illustrated on the right hand side of FIG. 2, the configurable attribute data portion 34 may comprise additional general information 36 and/or additional user-specific information 38.

The configurable attribute data portion 34 may be provided for each hierarchy level 26, 28, 30, 32 of the fixed attribute data portion 24.

Accordingly, additional general information 36 and/or additional user-specific information 38 may be provided for each of the hierarchy levels 26, 28, 30, 32 or for a certain subset of the hierarchy levels 26, 28, 30, 32.

The configurable attribute data portion 34 may be freely configurable, particularly via the user interface module 18, such that arbitrary additional information can be provided.

For example, the configurable attribute data portion may comprise additional definitions, comments, instructions for performing tests, additional test routines, test documentation, test reports, etc.

In fact, the user interface module 18 may be configured to receive a test adaptation request, wherein the configurable attribute data portion 24 of the test data is configurable by means of the test adaptation request.

Alternatively or additionally the user interface module 18 may be configured to receive a resource adaptation request, wherein the configurable attribute data portion 24 of the resource data is configurable by means of the resource adaptation request.

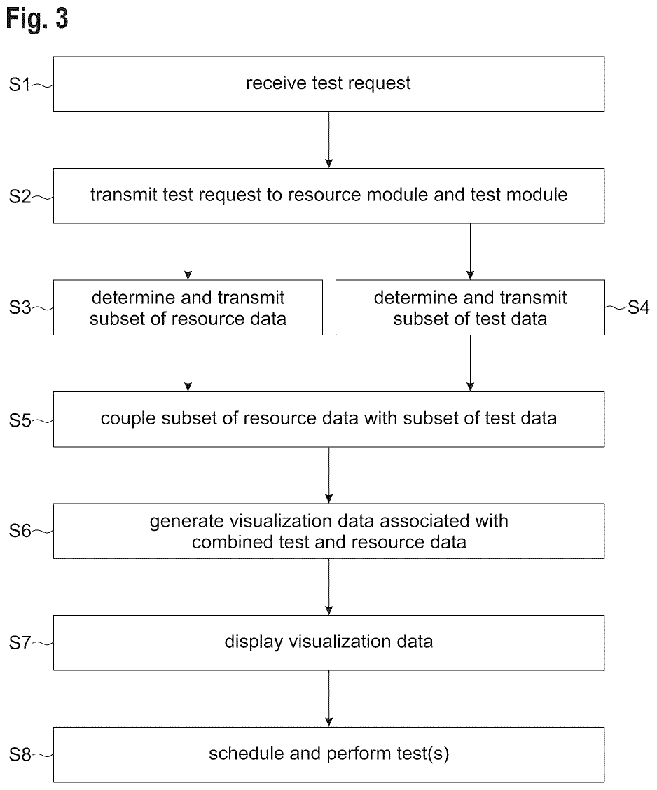

The test system 10 is configured to perform a testing method for performing tests on at least one device under test, which is described in the following with reference to FIG. 3.

A test request is received by means of the user interface module 18 (step S1).

In general, the test request is associated with at least one device under test that is to be tested, namely with at least one test that is to performed on the device under test.

For example, the user may enter a particular type of a device that is to be tested, a particular model of a device that is to be tested, or a particular serial number of a device that is to be tested.

Additionally or alternatively, the test request may comprise information on a manufacturing step associated with the requested test, e.g. whether the requested test relates to prototype testing, intermediate testing, or end-of-line testing.

Optionally, user identification data may be received by means of the user interface module 18.

For example, the user identification data may comprise a user name, a user password, a department of the user, a job position of the user, or other suitable information on the user.

The test request (and optionally the user identification data) is transmitted to the resource module 20 and to the test module 22, respectively (step S2).

A subset of the resource data corresponding to at least one test appliance matching the test request is determined and transmitted to the user interface module 18 by means of the resource module 20 (step S3).

In other words, the resource module 20 determines, based on the test request, which test appliance(s) is (are) suitable for performing the requested test. The transmitted subset of the resource data corresponds to the test appliance(s) being suitable for performing the requested test.

Optionally, the subset of the resource data may be determined and transmitted based on the user identification data. Accordingly, only resource data that is actually relevant for the user and/or only resource data that the user is granted access to is transmitted to the user interface module 18.

A subset of the test data corresponding to at least one test matching the test request is determined and transmitted to the user interface module 18 by means of the test module 22 (step S4).

Accordingly, the test module 22 determines, based on the test request, which test(s) is (are) suitable for performing the requested test. The transmitted subset of the test data corresponds to the test(s) being suitable for performing the requested test.

Optionally, the subset of the test data may be determined and transmitted based on the user identification data. Accordingly, only test data that is actually relevant for the user and/or only resource data that the user is granted access to is transmitted to the user interface module 18.

In fact, the subset of the test data and the subset of the resource data may be transmitted to the user interface module 18 in an asynchronous manner, i.e. the transfers of the subset of the test data and the subset of the resource data do not have to be synchronized with each other.

For example, the subset of the test data and the subset of the resource data are transmitted to the user interface module 18 by means of a message queuing protocol, particularly by means of an Advanced Message Queuing Protocol (AMQP).

The subset of the test data is coupled with the subset of the resource data by means of a data interface of the user interface module 18, thereby obtaining combined test and resource data (step S5).

Optionally, the data interface may couple the subset of the test data with the subset of the resource data based on the user identification data. This way, customized combined test and resource data may be obtained that comprises only information that is actually relevant to the particular user.

In the combined test and resource data, the information comprised in the subset of the test data and in the subset of the resource data is linked such that the combined test and resource data comprises information on viable combinations of tests and test appliances for the requested test(s).

Further, the combined test and resource data may comprise information on which test(s) can be conducted at which geographic location and/or at which point in time.

In a particular example, the combined test and resource data may comprise a list of viable combinations of tests and test appliances for the requested test(s), together with information on time slots at which these test appliances are free to use.

Accordingly, the combined test and resource data allows the user to configure the test(s) to be performed based on the information on viable combinations of tests and test appliances for the requested test(s). In fact, the combined test and resource data allows the user to schedule and perform the requested test(s) in an efficient manner.

Visualization data associated with the combined test and resource data is generated by means of the user interface module 18 (step S6).

The generated visualization data may, for example, comprise tables, diagrams, calendars, text fields, warning signs, and/or color-coded information.

The generated visualization data is displayed on a display, particularly on a display of the user device 16 (step S7).

Particularly, the user interface module 18 may comprise a graphical user interface that allows the user to interact with the generated visualization data. For example, a user may schedule at least one test on the at least one device under test by means of the graphical user interface.

However, it is also conceivable that at least one test is automatically scheduled and/or performed by means of the user device 16 based on the combined test and resource data (step S8).

In fact, the user device 16 may be configured to automatically control at least one test appliance based on the combined test and resource data, such that the at least one test is automatically performed on the at least one device under test.

1. A test system for performing tests on at least one device under test, wherein the test system comprises a resource module, a test module, and a user interface module,
wherein the resource module comprises a resource database, wherein the resource database comprises resource data associated with a plurality of different test appliances for performing tests on a plurality of different devices under test,
wherein the test module comprises a test database, wherein the test database comprises test data associated with a plurality of different tests for a plurality of different devices under test,
wherein the user interface module is configured to receive a test request from a user, wherein the test request is associated with the at least one device under test,
wherein the user interface module is configured to forward the test request to the test module and to the resource module,
wherein the test module is configured to selectively transmit at least a subset of the test data, the subset of the test data corresponding to at least one test matching the test request to the user interface module,
wherein the resource module is configured to selectively transmit at least a subset of the resource data, the subset of the resource data corresponding to at least one test appliance matching the test request to the user interface module; and
wherein the user interface module comprises a data interface, wherein the data interface is configured to couple the at least one subset of the test data with the at least one subset of the resource data, thereby obtaining combined test and resource data.

2. The test system of claim 1, wherein the data interface is configured to couple the subset of the test data with the subset of the resource data by an asynchronous data coupling.

3. The test system of claim 1, wherein the resource data comprises a fixed attribute data portion associated with the plurality of different test appliances, and/or wherein the test data comprises a fixed attribute data portion associated with the plurality of different tests.

4. The test system according to claim 1, wherein the resource data comprises a configurable attribute data portion associated with the plurality of different test appliances, and/or wherein the test data comprises a configurable attribute data portion associated with the plurality of different tests.

5. The test system according to claim 4, wherein the user interface module is configured to receive a test adaptation request, wherein the configurable attribute data portion of the test data is configurable by the test adaptation request.

6. The test system according to claim 4, wherein the user interface module is configured to receive a resource adaptation request, wherein the configurable attribute data portion of the resource data is configurable by the resource adaption request.

7. The test system according to claim 1, wherein the user interface module is configured to receive user identification data from a user.

8. The test system according to claim 7, wherein the data interface is configured to couple the subset of the test data with the subset of the resource data based on the user identification data.

9. The test system according to claim 7, wherein the user interface module is configured to forward the user identification data to the resource module, and wherein the resource module is configured to selectively transmit the subset of the resource data based on the user identification data.

10. The test system according to claim 7 wherein the user interface module is configured to forward the user identification data to the test module, and wherein the test module is configured to selectively transmit the subset of the test data based on the user identification data.

11. The test system according to claim 1, wherein the user interface module is configured to generate visualization data associated with the combined test and resource data.

12. The test system according to claim 1, wherein the test system comprises at least one server, wherein the resource module and/or the test module is implemented on the at least one server.

13. A testing method for performing tests on at least one device under test by a test system according to claim 1, the testing method comprising the steps of:
receiving, by a user interface module, a test request from a user, wherein the test request is associated with at least one device under test;
forwarding, by the user interface module, the test request to a test module comprising a test database and to a resource module comprising a resource database, wherein the test database comprises test data associated with a plurality of different tests for a plurality of different devices under test, and wherein the resource database comprises resource data associated with a plurality of different test appliances for performing tests on a plurality of different devices under test;
selectively transmitting, by the resource module, a subset of the resource data corresponding to at least one test appliance matching the test request to the user interface module;
selectively transmitting, by the test module, a subset of the test data corresponding to at least one text matching the test request to the user interface module; and
coupling, by a data interface of the user interface module, the subset of the test data with the subset of the resource data, thereby obtaining combined test and resource data.

14. The testing method of claim 13, wherein the subset of the test data is coupled with the subset of the resource data by an asynchronous data coupling.

15. The testing method of claim 13, wherein the subset of the test data is synchronized with the subset of the resource data by a message queuing protocol.
